(19) United States
(12) Patent Application Publication
(10) Pub. No.: US 2012/0193584 A1
(43) Pub. Date: Aug. 2, 2012

(54) CONDUCTIVE POLYMER COMPOSITION AND MANUFACTURING METHOD THEREOF

(75) Inventors: Yong Hyun Jin, Seoul (KR); Youn Soo Kim, Seoul (KR); Ji Soo Leo, Gyunggi-do (KR)

(73) Assignee: SAMSUNG ELECTRO-MECHANICS CO., LTD., Gyunggi-do (KR)

(21) Appl. No.: 13/050,137

(22) Filed: Mar. 17, 2011

(30) Foreign Application Priority Data
Feb. 1, 2011 (KR) 1020110010271

(51) Int. Cl. H01B 1/12

(52) U.S. Cl. 252/500

(57) ABSTRACT

Disclosed herein is a conductive polymer composition including: a conductive polymer doped with PCS (Poly cellulose-sulfonate); and a solvent. The conductive polymer composition is advantageous in that, since PCS (Poly cellulose-sulfonate) is used as a dopant, the crosslink density of a conductive polymer increases, thus improving the electrical conductivity and thermal stability of the conductive polymer composition.

### CROSS REFERENCE TO RELATED APPLICATION

This application claims the benefit of Korean Patent Application No. 10-2011-0010271, filed Feb. 1, 2011, entitled “Conductive polymer composition and manufacturing method thereof,” which is hereby incorporated by reference in its entirety into this application.

### BACKGROUND OF THE INVENTION

1. Technical Field

The present invention relates to a conductive polymer composition and a method of manufacturing the same.

2. Description of the Related Art

Development of auxiliary computer devices has taken place alongside the advancement of computers which use digital technology. Personal computers, portable transmitters, and other personal information processing apparatuses carry out the processing of text and graphics using input devices such as keyboards, mice and the like.

However, since computers are gradually being used for various purposes at the same time as the information society is rapidly advancing, there is a problem in that it is difficult to efficiently operate computers using keyboards and mice as the input devices. Therefore, there is an increasing demand to develop an input device which has a simple structure and does not cause erroneous operations and which can be used by users to easily input information and data.

Further, input devices must have high reliability, high durability, high innovativeness and high workability in addition to general functionality. In order to accomplish these purposes, a touch panel was developed as an input device capable of inputting information such as text, graphics and the like.

The touch panel is mounted on image display apparatuses, such as flat panel displays including electronic notebooks, liquid crystal displays (LCDs), plasma display panels (PDPs), electroluminescence panels, etc., and cathode ray tubes (CRTs), and is used to enable users to select desired information while viewing an image display apparatus.

Touch panels are classified into resistive touch panels, capacitive touch panels, electromagnetic touch panels, surface acoustic wave (SAW) type touch panels, and infrared touch panels. These various types of touch panels are employed in electronic products in consideration of the problem of signal amplification, the differences of resolution, the difficulty in design and machining techniques, optical characteristics, electrical characteristics, mechanical characteristics, environment-resistant characteristics, input characteristics, durability, and economical efficiency. Currently, among these touch panels, resistive touch panels are the most widely used.

Resistive touch panels are configured such that upper and lower transparent electrodes are spaced apart from each other by a spacer and are brought into contact with each other by pressing. When an upper conductive film provided with an upper transparent electrode is pressed by an input means such as a finger, a pen or the like, upper and lower transparent electrodes electrically communicate with each other, and the voltage change attributable to the resistance change at that point is recognized by a control unit, thus recognizing contact coordinates. Resistive touch panels include digital resistive touch panels and analog resistive touch panels.

Capacitive touch panels are configured such that an upper conductive film provided with a first transparent electrode and a lower conductive film provided with a second a first transparent electrode and a lower conductive film provided with a second transparent electrode are spaced apart from each other, and an insulator is interposed between the upper conductive film and the lower conductive film in order that the first transparent electrode and the second transparent electrode may not come into contact with each other. Further, each of the upper and lower conductive films is provided with electrode wiring connected with each of the first and second transparent electrodes. The electrode wiring serves to transfer the capacitance change induced by pressing the touch panel using an input means to a control unit.

Conventionally, transparent electrodes have been made of Indium Tin Oxide (ITO), but, currently, research into a conductive polymer as an alternative material of ITO is being actively carried out. Such a conductive polymer is advantageous in that it has excellent flexibility and its coating process is simple. Owing to this advantage, it is expected that a conductive polymer will attract considerable attention as an essential component of next-generation flexible displays as well as touch panels.

However, such as conductive polymer is problematic in that it has a relatively low electrical conductivity of 0.1 S/cm˜100 S/cm compared to that of ITO. Further, conventional conductive polymers are problematic in that, when they are heated, their arrangement becomes irregular, so that their electrical conductivity greatly changes, thereby deteriorating their stability.

### SUMMARY OF THE INVENTION

Accordingly, the present invention has been devised to solve the above-mentioned problems, and the present invention intends to provide a conductive polymer composition including a conductive polymer doped with polycellulose sulfonate (PCS) and a method of manufacturing the same.

An aspect of the present invention provides a conductive polymer composition, including:

a solvent; and

a conductive polymer doped with PCS (polycellulose sulfonate) represented by Formula 1 below:

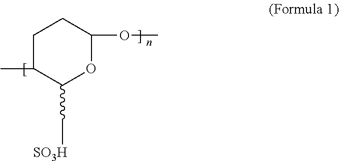

wherein n is an integer of 2 or more.

Here, the conductive polymer composition may include 0.1˜50 wt % of the conductive polymer doped with PCS (Polycellulose sulfonate) and 50˜99.9 wt % of the solvent. Further, the conductive polymer doped with PCS (Polycellulose sulfonate) may be any one selected from a polythiophene-based conductive polymer, a polypyrrole-based conductive polymer, a polyphenylene-based conductive polymer, a polyaniline-based conductive polymer, and a polyacetylene-based conductive polymer.

Further, the polythiophene-based conductive polymer may be polytheylenedioxythiophene/polycellulosesulfonate (PEDOT/PCS).

Further, the solvent may be any one selected from water, aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, and mixtures thereof.

Further, the conductive polymer composition may further include: a secondary dopant. Further, the secondary dopant may be any one polar solvent selected from dimethylsulfoxide (DMSO), N-methylpyrrolidone (NMP), N,N-dimethylformamide (DMF), and N-dimethylacetimide (DMA), and mixtures thereof.

Further, the conductive polymer composition may further include: a binder.

Further, the binder may be any one selected from an acrylic binder, an epoxy binder, an ester binder, a urethane binder, an ether binder, a carboxylic binder, an amide binder, and mixtures thereof.

Another aspect of the present invention provides a method of manufacturing a conductive polymer composition, including: preparing a conductive polymer monomer solution including a conductive polymer monomer, PCS (Polycellulose sulfonate) and a solvent; and polymerizing the conductive polymer monomer solution.

Here, the polymerizing of the conductive polymer monomer solution may be performed by oxidation polymerization using an oxidant.

Further, the conductive polymer monomer solution may include 0.1˜50 wt % of the conductive polymer monomer, 0.01˜10 wt % of the PCS (Polycellulose sulfonate), and 40˜99 wt % of the solvent.

Further, the conductive polymer monomer may be any one selected from the group consisting of thiophene, aniline, pyrrole, acetylene, phenylene, and derivatives thereof.

Further, the conductive polymer monomer may be 3,4-ethylenedioxythiophene (EDOT).

Further, the solvent may be any one selected from water, aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, and mixtures thereof.

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing a structure of PCS (polycellulose sulfonate);

FIG. 2 is a view showing the change in the structure of PCS (polycellulose sulfonate) when PCS dissolves in water; and

FIG. 3 is a view showing the chemical reaction of polymerizing EDOT (conductive polymer monomer) by doping EDOT with PCS (polycellulose sulfonate).

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

invention, the description thereof will be omitted.

Hereinafter, preferred embodiments of the present invention will be described in detail with reference to the attached drawings.

The present invention provides a conductive polymer composition including a conductive polymer doped with PCS (polycellulose sulfonate) and a solvent. In the conductive polymer composition, since PCS (polycellulose sulfonate) is used as a dopant, the crosslink density of a conductive polymer increases, thus improving the electrical conductivity and thermal stability of the conductive polymer composition. Hereinafter, the conductive polymer composition will be described in detail depending on its constituents.

First, a conductive polymer, which is a polymer having electrical conductivity of one πelectron per carbon atom, has a molecular weight of about 10,000 or more. A conductive polymer is advantageous in that it is lighter than Indium Tin Oxide (ITO) commonly used to make transparent electrodes and in that it can be used to form a highly-flexible thin film.

A dopant is a material serving as a charge carrier for providing an electric charge to a part of a πorbital and removing an electric charge therefrom. A dopant is generally added in order to provide electrical conductivity to a conductive polymer. A process of making a charge carrier by adding a dopant to a conductive polymer is referred to as “doping”. Concretely, a process of providing an electric charge to a conductive polymer is referred to as “reduction doping (n-type doping)”, and a process of removing an electric charge from a conductive polymer is referred to as “oxidation doping (p-type doping)”.

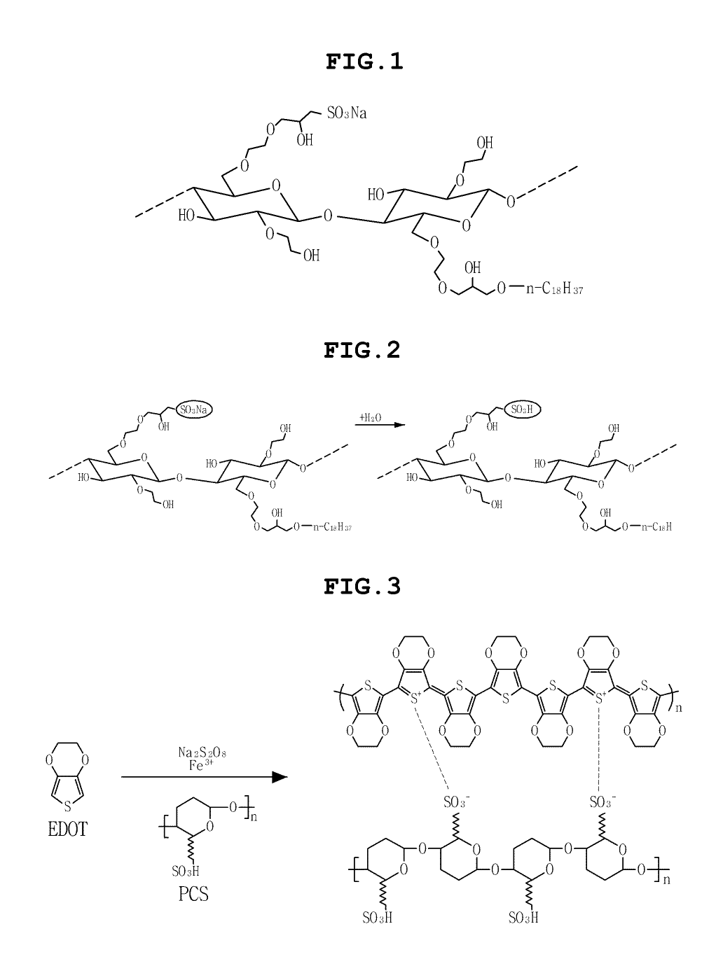

In the present invention, a conductive polymer is doped with PCS (polycellulose sulfonate), thus improving the electrical conductivity and thermal stability of the conductive polymer composition. In this case, PCS (polycellulose sulfonate), used as a dopant, is a white or light yellow material having a structure of FIG. 1. When PCS dissolves in water, as shown in FIG. 2, sodium ion (Nat) dissociates, and simultaneously hydrogen ion (H+) is FIG. 2, sodium ion (Na⁺) dissociates, and simultaneously hydrogen ion (H+) is covalently-bonded with a sulfonate group to form a sulfonic acid group. Hereinafter, the principle of improving electrical conductivity and thermal stability by doping a conductive polymer with PCS (polycellulose sulfonate) will be described in detail by way of example.

As shown in FIG. 3, when the conductive polymer monomer EDOT is oxidation-polymerized, the cation of PEDOT and the sulfonate anion of PCS are attracted to each other by electric force, thus forming a long chain. In this case, since PCS includes a hydroxy group (OH), the crosslink density of conductive polymer chains is increased by the hydrogen bond between PCS molecules. Therefore, the distance between conductive polymers (PEDOT) decreases, improving the electrical conductivity of the conductive polymer composition of the present invention. Further, since the crosslink density of the conductive polymer chains is high, the stability of the molecular structure of the conductive polymer increases, so that the conductive polymer chains are not greatly deformed, thereby maintaining the electrical characteristics of the conductive polymer composition. Meanwhile, the effects of the improvement of electrical conductivity and thermal stability by the doping of PCS (poly cellulose-sulfonate) may be applied to another conductive polymer as well as to the exemplified PEDOT.

Here, the conductive polymer doped with PCS (polycellulose sulfonate) is any one selected from a polythiophene-based conductive polymer, a polypyrrole-based conductive polymer, a polyphenylene-based conductive polymer, a polyaniline-based conductive polymer, and a polyacetylene-based conductive polymer.

In this case, the polythiophene-based conductive polymer is polytheylenedioxythiophene/polycellulosesulfonate (PEDOT/PCS). PEDOT/PCS is advantageous in that it has high electrical conductivity, thermal stability and transparency.

In the conductive polymer composition of the present invention, the conductive polymer doped with PCS (polycellulose sulfonate) is included in an amount of 0.1˜50 doped with PCS (polycellulose sulfonate) is included in an amount of 0.1˜50 wt %, preferably, 1˜3 wt %. When the amount of the conductive polymer doped with PCS is less than 0.1 wt %, it is difficult to realize high electric conductivity of a surface resistance of 1 kΩ/□ or less. Further, when the amount thereof is more than 50 wt %, the amount of conductive polymers having colorability increases, thus deteriorating the transmittance of a transparent electrode.

Subsequently, a solvent is added to disperse the conductive polymer in a solution. The solvent may be any one selected from water, aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, and mixtures thereof. However, the solvent is not limited thereto.

In the conductive polymer composition of the present invention, the solvent is included in an amount of 50˜99.9 wt %, preferably, 60˜99 wt %. The solvent is added to disperse the conductive polymer in a solution. When the amount of the solvent is less than 50 wt %, the dispersibility of the conductive polymer in the solvent decreases. Further, when the amount thereof is more than 99.9 wt %, the electrical conductivity of the conductive polymer composition decreases.

The conductive polymer composition of the present invention may further include a secondary dopant. The secondary dopant provides a screen effect between a conductive polymer and PCS to allow PCS having low electrical conductivity to be spaced apart from a conductive polymer, thus improving the electrical conductivity of the conductive polymer composition. The secondary dopant does not remain as a dopant because it causes the conductive polymer to be structurally changed, but it exhibits the same doping effect as a dopant. The secondary dopant may be an organic compound containing oxygen and nitrogen. The secondary dopant may be an ether group-containing compound, a carbonyl group-containing compound, a polar solvent, and a mixture thereof.

containing compound, a polar solvent, and a mixture thereof.

Diethylene glycol monoethyl ether or the like is used as the ether group-containing compound. Isophorone, propylene carbonate, cyclohexanone, butyrolactone or the like is used as the carbonyl group-containing compound.

In this case, preferably, a polar solvent may be used as the secondary dopant. The polar solvent is advantageous in that it greatly improves the electrical conductivity of the conductive polymer composition. The polar solvent may be dimethylsulfoxide (DMSO), N-methylpyrrolidone (NMP), N,N-dimethylformamide (DMF), N-dimethylacetimide (DMA), and a mixture thereof.

In the conductive polymer composition, the secondary dopant is included in an amount of 0.5˜15 wt %, preferably, 1.5˜5 wt %. When the amount of the secondary dopant is less than 0.5 wt %, the effect of the improvement of the electrical conductivity of the conductive polymer composition is insufficient. Further, when the amount thereof is more than 15 wt %, the effect of the improvement of the electrical conductivity thereof does not exist, thus squandering the secondary dopant.

The conductive polymer composition of the present invention may further include a binder. The binder serves to improve the adhesivity between the conductive polymer composition and a substrate. The binder may be any one selected from an acrylic binder, an epoxy binder, an ester binder, a urethane binder, an ether binder, a carboxylic binder, an amide binder, and mixtures thereof.

In this case, the binder is included in an amount of 0.5˜10 wt %, preferably, 2˜8 wt %. When the amount of the binder is less than 0.5 wt %, the effect of the improvement of the adhesivity is insufficient. Further, when the amount thereof is more than 10 wt %, the ratio of the binder to the conductive polymer is relatively increased, thus decreasing the electrical conductivity of the conductive polymer composition.

The conductive polymer composition may further include another additive such as a dispersion stabilizer, a surfactant or the like in addition to the binder.

Further, the present invention provides a method of manufacturing a conductive polymer composition, including: preparing a conductive polymer monomer solution including a conductive polymer monomer, PCS (polycellulose sulfonate) and a solvent; and polymerizing the conductive polymer monomer solution. In the method of the present invention, when the conductive polymer monomer solution is polymerized into a conductive polymer, the conductive polymer is doped using PCS (polycellulose sulfonate) as a dopant, thus improving the electrical conductivity and thermal stability of the conductive polymer composition. Hereinafter, the method of manufacturing a conductive polymer composition will be described in detail by processes. A description overlapping with the above description will be omitted or briefly mentioned.

First, a conductive polymer monomer solution including a conductive polymer monomer, PCS (polycellulose sulfonate) and a solvent is prepared. Here, the conductive polymer monomer may be thiophene, aniline, pyrrole, acetylene, phenylene, or a derivative thereof. Preferably, the conductive polymer monomer may be 3,4-ethylenedioxythiophene (EDOT). The polyethylenedioxythiophene (PEDOT) obtained by polymerizing the conductive polymer monomer (EDOT) is advantageous in that it has high electrical conductivity and transparency.

In this case, the conductive polymer monomer is included in the conductive polymer monomer solution in an amount of 0.1˜50 wt %, preferably, 1˜3 wt %. When the amount of the conductive polymer monomer is less than 0.1 wt %, the electrical conductivity of the conductive polymer composition becomes low. When the amount thereof is more than 50 wt %, the transmittance of the conductive polymer composition becomes low, and the workability thereof becomes poor.

Further, PCS (polycellulose sulfonate) is added as a dopant. In the present invention, since PCS (polycellulose sulfonate) is used as a dopant at the time of polymerizing the conductive polymer monomer, a conductive polymer doped with PCS can be prepared. The conductive polymer doped with PCS has excellent electrical conductivity of a surface resistance of 500 Ω/□ or less, and has high stability to heat because its molecular structure is slightly changed by heat.

In this case, the PCS (polycellulose sulfonate) is included in the conductive polymer monomer solution in an amount of 0.01˜10 wt %, preferably, 0.1˜3 wt %. When the amount of the PCS is less than 0.01 wt %, the doping effect of the conductive polymer becomes low. Further, when the amount thereof is more than 10 wt %, the effect of the improvement of electrical conductivity of the conductive polymer due to the addition of the PCS is insufficient.

Further, a solvent serves to dissolve the conductive polymer monomer and PCS to disperse them. The solvent is included in the conductive polymer monomer solution in an amount of 40%˜99 wt %.

Subsequently, the conductive polymer monomer solution is polymerized. A conductive polymer doped with PCS can be obtained by polymerizing the conductive polymer monomer solution. The conductive polymer monomer solution is prepared by chemical polymerization, electrochemical polymerization, thermal polymerization, photopolymerization or the like.

Here, it is preferred that the polymerization of the conductive polymer monomer solution be conducted by oxidation polymerization of chemical polymerization. Oxidation polymerization is advantageous that it can be conducted at low cost and in a simple manner. In the oxidation polymerization, an oxidant, such as ammonium peroxy disulfate (APS), hydrochloric acid (HCl) or Lewis acid, is added to the conductive polymer monomer solution to allow the conductive polymer monomer to be oxidized such that it is easily allow the conductive polymer monomer to be oxidized such that it is easily polymerized, and then the oxidized conductive polymer monomer is polymerized into a conductive polymer. In this case, the oxidant is added in an amount of 0.0001˜4 mol based on 1 mol of the conductive polymer monomer.

The present invention will be described in more detail with reference to the following Examples. However, the scope of the present invention is not limited thereto.

### EXAMPLE 1

Water as a solvent, 3,4-ethylenedioxythiophene (EDOT) as a conductive polymer monomer, and PCS (polycellulose sulfonate) as a dopant were put into a 100 mL round reactor, and were then stirred and ultrasonicated to prepare a conductive polymer monomer solution. In this case, the prepared conductive polymer monomer solution includes 69.7 wt % of water, 30 wt % of EDOT and 0.3 wt % of PCS. Subsequently, 14.08 mmol of Fe₂(SO₄)₃5H₂O as an oxidant was added to the conductive polymer monomer solution, and then the conductive polymer monomer solution was oxidation-polymerized at 25° C. for 3 hours to manufacture a conductive polymer composition. This conductive polymer composition was applied onto a substrate and then dried in an oven at 100° C. for 2 minutes to form a conductive film.

### EXAMPLE 2

A conductive polymer composition was manufactured in the same manner as in Example 1, except that a conductive polymer monomer solution includes 69.3 wt % of water, 30 wt % of EDOT and 0.7 wt % of PCS.

This conductive polymer composition was applied onto a substrate and then dried in an oven at 100° C. for 2 minutes to form a conductive film.

### EXAMPLE 3

A conductive polymer composition was manufactured in the same manner as in Example 1, except that a conductive polymer monomer solution includes 69.1 wt % of water, 30 wt % of EDOT and 0.9 wt % of PCS.

This conductive polymer composition was applied onto a substrate and then dried in an oven at 100° C. for 2 minutes to form a conductive film.

### EXAMPLE 4

A conductive polymer composition was manufactured in the same manner as in Example 1, except that a conductive polymer monomer solution includes 68.8 wt % of water, 30 wt % of EDOT and 1.2 wt % of PCS.

This conductive polymer composition was applied onto a substrate and then dried in an oven at 100° C. for 2 minutes to form a conductive film.

### COMPARATIVE EXAMPLE 1

A conductive polymer composition was manufactured in the same manner as in Example 1, except that polystyrene sulfonate (PSS) is used as a dopant instead of polycellulose sulfonate (PCS) and that a conductive polymer monomer solution includes 69.7 wt % of water, 30 wt % of EDOT and 0.3 wt % of PSS.

This conductive polymer composition was applied onto a substrate and then dried in an oven at 100° C. for 2 minutes to form a conductive film.

### COMPARATIVE EXAMPLE 2

A conductive polymer composition was manufactured in the same manner as in Example 1, except that polystyrene sulfonate (PSS) is used as a dopant instead of polycellulose sulfonate (PCS) and that a conductive polymer monomer solution includes 69.3 wt % of water, 30 wt % of EDOT and 0.7 wt % of PSS.

This conductive polymer composition was applied onto a substrate and then dried in an oven at 100° C. for 2 minutes to form a conductive film.

### TEST EXAMPLE

The surface resistances of the conductive films formed of the conductive polymer compositions of Examples 1 to 4 and Comparative Examples 1 and 2 before and after heat treatment were evaluated. The surface resistances thereof were evaluated using Loresta EP MCP-T360 manufactured by Mitsubishi Chemical Corporation. Heat treatment was conducted in an oven at 150° C. for 30 minutes.

TABLE 1

| | Before heat treatment | | After heat treatment | |
|---|---|---|---|---|
| | Surface | | Surface | |
| | resistance | Degree of scatter | resistance | Degree of |
| | (Ω/□) | (%) | (Ω/□) | scatter (%) |
| Exp. 1 | 157.0 | 6.4 | 163.8 | 12.2 |
| Exp. 2 | 181.0 | 7.9 | 199.1 | 12.6 |
| Exp. 3 | 195.3 | 7.5 | 211.4 | 12.5 |
| Exp. 4 | 238.5 | 8.1 | 251.3 | 12.8 |
| Comp. Exp. 1 | 212.8 | 15.0 | 224.0 | 33.5 |
| Comp. Exp. 2 | 265.2 | 15.5 | 278.8 | 33.7 |

From the results given in Table 1 above, it can be seen that the conductive polymer (PEDOT/PCS) doped with PCS has higher electrical conductivity than that of the conductive polymer (PEDOT/PSS) doped with PSS because the surface resistance of the conductive polymer (PEDOT/PCS) is lower than that of the conductive polymer (PEDOT/PSS). Further, it can be seen that PEDOT/PCS has excellent thermal stability because the degree of scatter of surface resistance values of PEDOT/PCS is low.

surface resistance values of PEDOT/PCS is low.

As described above, according to the present invention, since a conductive polymer is doped with PCS (Poly cellulose-sulfonate), its crosslink density becomes high, thus improving its electrical conductivity.

Further, according to the present invention, since the conductive polymer composition including the conductive polymer doped with PCS (Poly cellulose-sulfonate) has high structural stability, its electrical conductivity is not greatly changed by heat.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Simple modifications, additions and substitutions of the present invention belong to the scope of the present invention, and the specific scope of the present invention will be clearly defined by the appended claims.

What is claimed is:

1. A conductive polymer composition, comprising:
a solvent; and
a conductive polymer doped with PCS (Poly cellulose-sulfonate) represented by Formula 1 below: 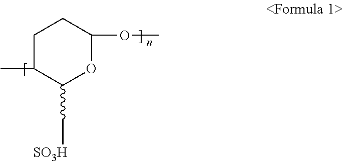
wherein n is an integer of 2 or more.

2. The conductive polymer composition according to claim 1, wherein the composition comprises 0.1˜50 wt % of the conductive polymer doped with PCS (Poly cellulose-sulfonate) and 50˜99.9 wt % of the solvent.

3. The conductive polymer composition according to claim 1, wherein the conductive polymer doped with PCS (Poly cellulose-sulfonate) is any one selected from a polythiophene-based conductive polymer, a polypyrrole-based conductive polymer, a polyphenylene-based conductive polymer, a polyaniline-based conductive polymer, and a polyacetylene-based conductive polymer.

4. The conductive polymer composition according to claim 3, wherein the polythiophene-based conductive polymer is polytheylenedioxythiophene/polycellulosesulfonate (PEDOT/PCS).
(PEDOT/PCS).

5. The conductive polymer composition according to claim 1, wherein the solvent is any one selected from water, aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, and mixtures thereof.

6. The conductive polymer composition according to claim 1, further comprising: a secondary dopant.

7. The conductive polymer composition according to claim 6, wherein the secondary dopant is any one polar solvent selected from dimethylsulfoxide (DMSO), N-methylpyrrolidone (NMP), N,N-dimethylformamide (DMF), N-dimethylacetimide (DMA), N-dimethylacetimide, and mixtures thereof.

8. The conductive polymer composition according to claim 1, further comprising: a binder.

9. The conductive polymer composition according to claim 8, wherein the binder is any one selected from an acrylic binder, an epoxy binder, an ester binder, a urethane binder, an ether binder, a carboxylic binder, an amide binder, and mixtures thereof.

10. A method of manufacturing a conductive polymer composition, comprising:
preparing a conductive polymer monomer solution including a conductive polymer monomer, PCS (Poly cellulose-sulfonate) and a solvent; and
polymerizing the conductive polymer monomer solution.

11. The method of manufacturing a conductive polymer composition according to claim 10, wherein the polymerizing of the conductive polymer monomer solution is performed by oxidation polymerization using an oxidant.

12. The method of manufacturing a conductive polymer composition according to claim 10, wherein the conductive polymer monomer solution comprises 0.1˜50 wt % of the conductive polymer monomer, 0.01˜10 wt % of the PCS (Poly cellulose-sulfonate), and 40˜99 wt % of the solvent.

13. The method of manufacturing a conductive polymer composition according to claim 10, wherein the conductive polymer monomer is any one selected from the group consisting of thiophene, aniline, pyrrole, acetylene, phenylene, and derivatives thereof.

14. The method of manufacturing a conductive polymer composition according to claim 10, wherein the conductive polymer monomer is 3,4-ethylenedioxythiophene (EDOT).

15. The method of manufacturing a conductive polymer composition according to claim 10, wherein the solvent is any one selected from water, aliphatic alcohols, aliphatic ketones, aliphatic carboxylic acid esters, aliphatic carboxylic acid amides, aromatic hydrocarbons, aliphatic hydrocarbons, acetonitrile, aliphatic sulfoxides, and mixtures thereof.
